(19) United States
(12) Patent Application Publication
(10) Pub. No.: US 2015/0120543 A1
(43) Pub. Date: Apr. 30, 2015

(54) EyeWatch ATM and Wire Transfer Fraud Prevention System

(71) Applicant: Kenneth Carnesi, SR., Garden City, NY (US)

(72) Inventor: Kenneth Carnesi, SR., Garden City, NY (US)

(21) Appl. No.: 14/120,532

(22) Filed: May 30, 2014

(51) Int. Cl. G06Q 20/40; G06K 9/00; G06Q 20/10

(52) U.S. Cl. CPC G06Q 20/40145; G06Q 20/108; G06Q 20/1085; G06K 9/00604; G06K 9/00617
USPC 705/43; 705/42; 382/117

(57) ABSTRACT

A method of iris scanning and proximity sensing, which includes receiving and photographing an iris in the iris scanning mode of the subject computer, laptop, mobile device or tablet, smartphone or i-phone; sensing for the available amount of necessary light and whether the iris is within the desired range to ensure proper acquisition of the sample. The iris is then photographed. The method provides for recognizing the iris utilizing the previously photographed iris image and converting the photographed iris image to an encrypted mathematical value, which will then be stored within the acquiring electronic device such as computer, laptop, smartphone; i-phone; mobile device or tablet, to be compared for future reference against any subject photographed iris. If any subsequently photographed iris matches the encrypted mathematical stored image, access to the device is granted. If the subsequently photographed iris does not match the encrypted mathematical stored image, access is denied.

A method of credit card fraud prevention, utilizing the iris scan image converted to an encrypted mathematical value as stated above, as a means of authentication and identification prior to the authorization of the credit card transaction. The iris scan methodology in this present invention can be used for authentication and identification for all ATM transactions and for bank wire transfer transactions over the internet and mobile channels. The iris image of the User converted to an encrypted mathematical value and residing on the User's mobile device or tablet, smartphone, i-phone, computer or laptop, or with the User's prior opt-in express consent, residing on the respective issuing bank's remote server, will prevent fraudulent use of the User's ATM card by denying access to the ATM card to anyone other than User, whose iris image resides on the User's respective device or the issuing bank's remote server.

### BACKGROUND OF INVENTION

1. Field of Invention

The present invention relates to a method for iris scanning; conversion of the scanned image to an encrypted mathematical value; storage of the encrypted mathematical value within a selected computer, laptop, mobile device or tablet; smartphone or i-phone and the use of the stored encrypted mathematical value in comparison against any other later acquired iris scans in order to determine an exact match to be used for authentication and identification purposes.

Particularly, access to the subject computer, laptop, mobile device; smartphone or i-phone would be blocked unless the acquired iris scan is an exact match with the prior acquired iris scan stored as an encrypted mathematical value within the subject computer, laptop, mobile device or tablet; smartphone or i-phone.

Further, in the case of ATM card information stored in a mobile device or tablet, smartphone, i-phone, computer or laptop, any ATM transaction or bank wire transfer transaction, would require the User to scan his/her iris image prior to completion of the transaction. If the iris scan does not match the encrypted mathematical value stored on the User's respective device or on the issuing bank's remote server, the ATM or bank wire transfer transaction would not be authorized. This present invention can be used as authentication for point-of-sale; internet and mobile credit card transactions and effectively block anyone but the authorized User from completing the transaction.

2. Description of Related Art

Iris scanning technology is used to collect and compare information on specific characteristics of the respective attributes of subject irises of individuals and to use that collected information in authentication and identification for the purpose of security. Every human iris has unique patterns, whose number is greater than that of the human fingerprint and therefore, for purposes of identification, is more accurate than fingerprints or even DNA. Also, iris scanning, unlike fingerprinting or retina scans, is a non-contact form of acquisition and scanning for purposes of authentication, which leads to an easier, faster and more comfortable identification and authentication process. The process of the acquisition of a sample iris scan takes less than 10 seconds and can be accurate even if the subject is wearing glasses or contact lenses. As a result, iris scans are being evaluated today as a better, more accurate form of biometric identification technology than even fingerprinting, voice sampling or retina scanning technology.

As computers, laptops, mobile devices and tablets, smartphones and i-phones become rapidly more sophisticated and more robust, the amount of information that can be stored within these devices increases. This increase in important stored information, personal and financial, now requires that the security technology for said devices also must increase in sophistication. As described above, the iris scan technology is more advanced and more accurate than other available biometric technologies. However, the Users of these devices are wary of having their iris samples stored in remote servers where they can be hacked and lost or misused.

The present invention answers these concerns by providing first, that the iris scan samples are stored only as encrypted mathematical values relatively useless to anyone but the respective individual and second, by providing that the encrypted mathematical value is stored only on the individuals' computer, laptop, mobile device or tablet, smartphone or i-phone to be used for authentication and security purposes.

As a result, the security of these devices may be more strengthened and the subject devices may now provide various services related with the authentication and identification of the User; such as authentication of ATM card transactions or bank wire transfer transactions over the internet or over mobile channels.

### SUMMARY OF THE INVENTION

The present invention allows first for the acquisition of a subject's iris scan and for the conversion of the physical iris scan sample to an encrypted mathematical value. The present invention then provides for the storage of that mathematical value within the respective computer, laptop, mobile device or tablet, smartphone or i-phone. Finally, the present invention provides for an algorithm which will compare any subsequently acquired iris scan against the encrypted mathematical value stored within the respective device. If the acquired iris scan matches the encrypted mathematical value, access to the device is permitted. If the subsequently acquired iris scan does not match the encrypted mathematical value stored on the respective mobile device, access to the device will be denied.

The present invention prevents ATM card fraud by using the stored and encrypted mathematical value, which represents the User's iris image, as a point of identification and authentication. As a result, anytime the User performs an ATM card transaction at an ATM terminal; or over internet or mobile channels, or the User attempts a bank wire transfer of funds over the internet or mobile channels, the purported. User will be required to scan his/her iris. If that scanned iris image does not exactly match the prior stored and encrypted image, the respective ATM card transaction or bank wire transfer transaction will be denied. This method of authentication prevents the use of the ATM card at ATM terminals, or the acceptance of bank wire transfer instructions, over the internet or mobile channels, by anyone other than the User.

### BRIEF DESCRIPTION OF THE DRAWINGS

These and other features, aspects and advantages of the present disclosure will become better understood when following detailed description is read with reference to the accompanying drawings in which like characters represent like parts throughout the drawings, wherein:

FIG. 1. is a flow chart view of the Iris Scan or Image Acquisition Process. It demonstrates each step necessary during the iris scanning mode activated on the electronic or mobile device or mobile telephone device being used. It also demonstrates the light and proximity sensors to ensure proper imaging.

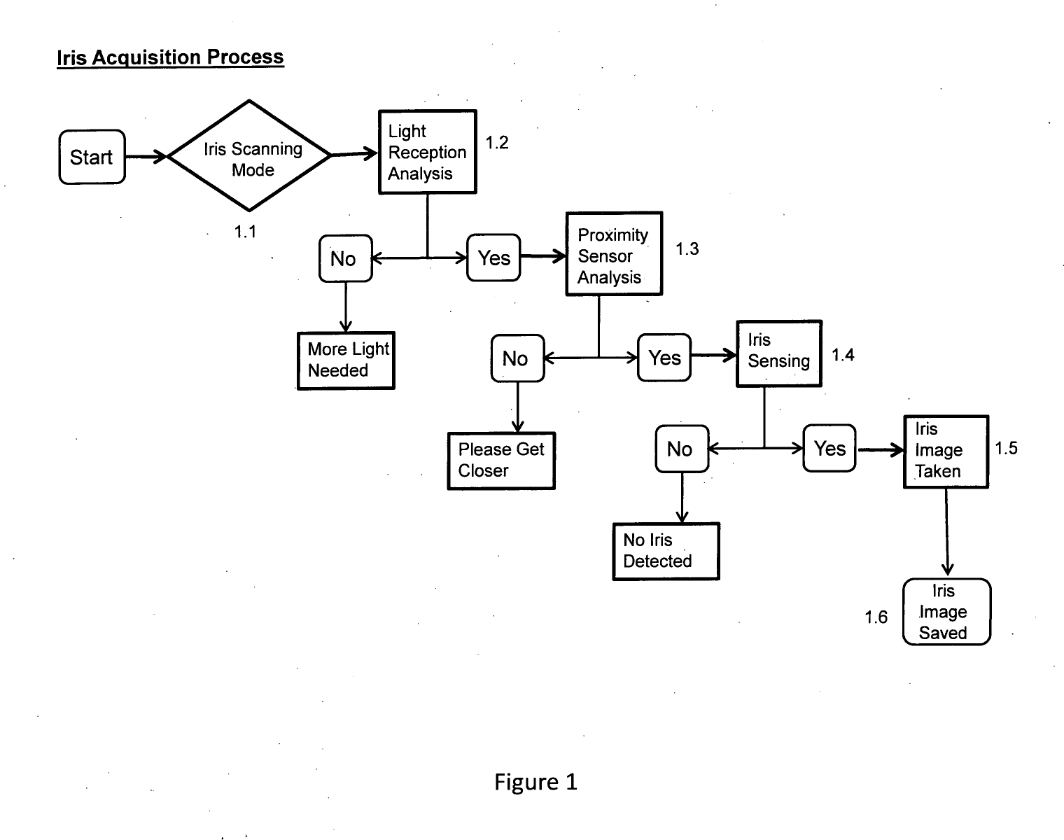

FIG. 2. is a flow chart view of the process of converting the photographic image of the iris acquired in the prior iris image acquisition mode to an encrypted mathematical value, to be stored in the electronic or mobile device or mobile telephone device being used.

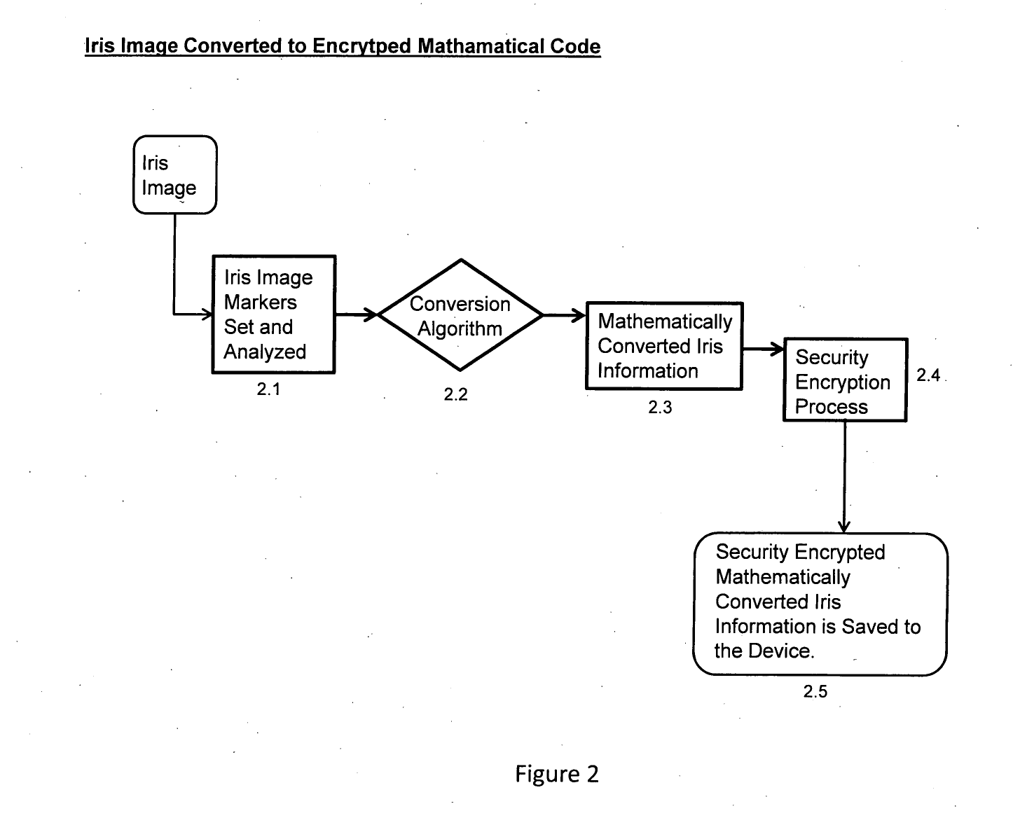

FIG. 3. is a flow chart view of the Iris Identification Process demonstrating the process of setting identification markers and the application of the authentication algorithm, which compares the encrypted mathematical value, stored on the respective electronic, mobile or mobile phone device, to any after acquired iris scans for purposes of authentication and identification.

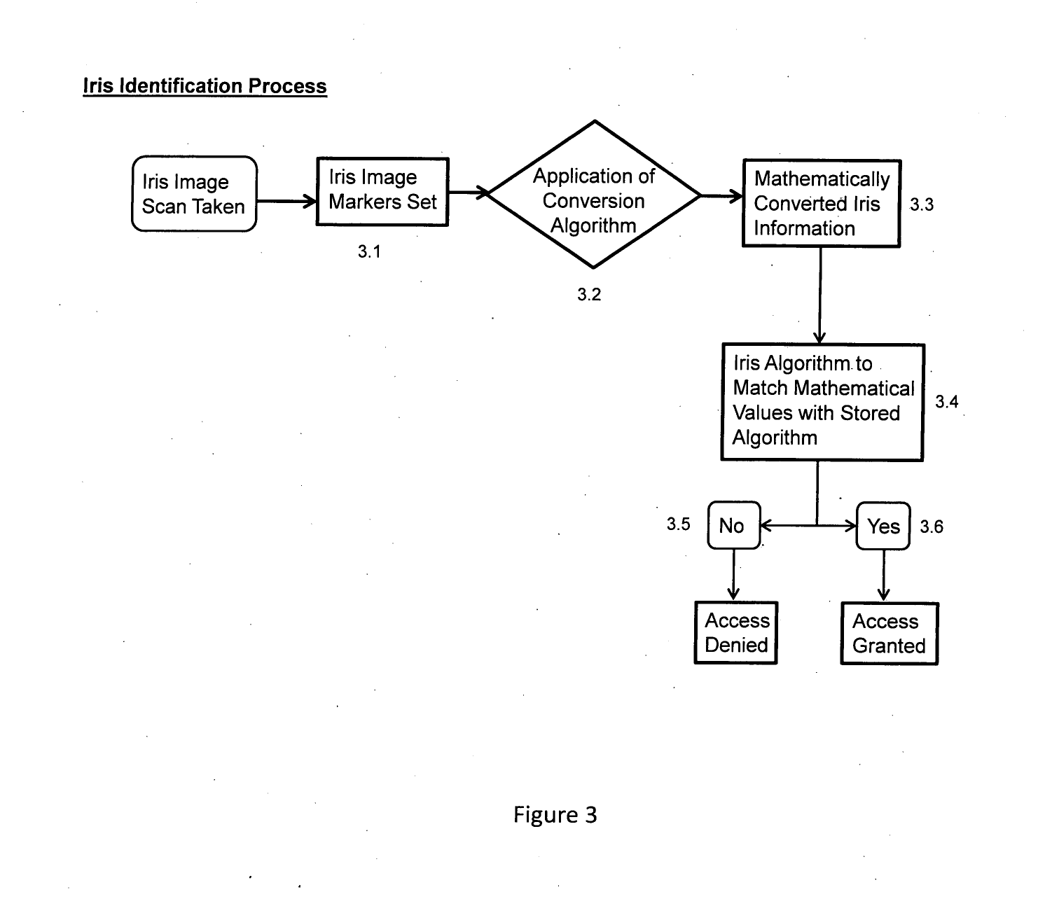

FIG. 4. is a flow chart view of the method of authentication and identification in ATM card transactions at an ATM terminal, using the encrypted mathematical value stored in the respective electronic, mobile or mobile telephone device or in the issuing bank's remote server, as identification of the ATM card Owner, prior to approval of any ATM card transaction. In this case, the encrypted mathematical value representing the ATM card Owner's iris image may also be stored, with the Owner's prior opt-in express consent, on a remote issuing bank verification center server. If the two images do not match, the transaction is refused.

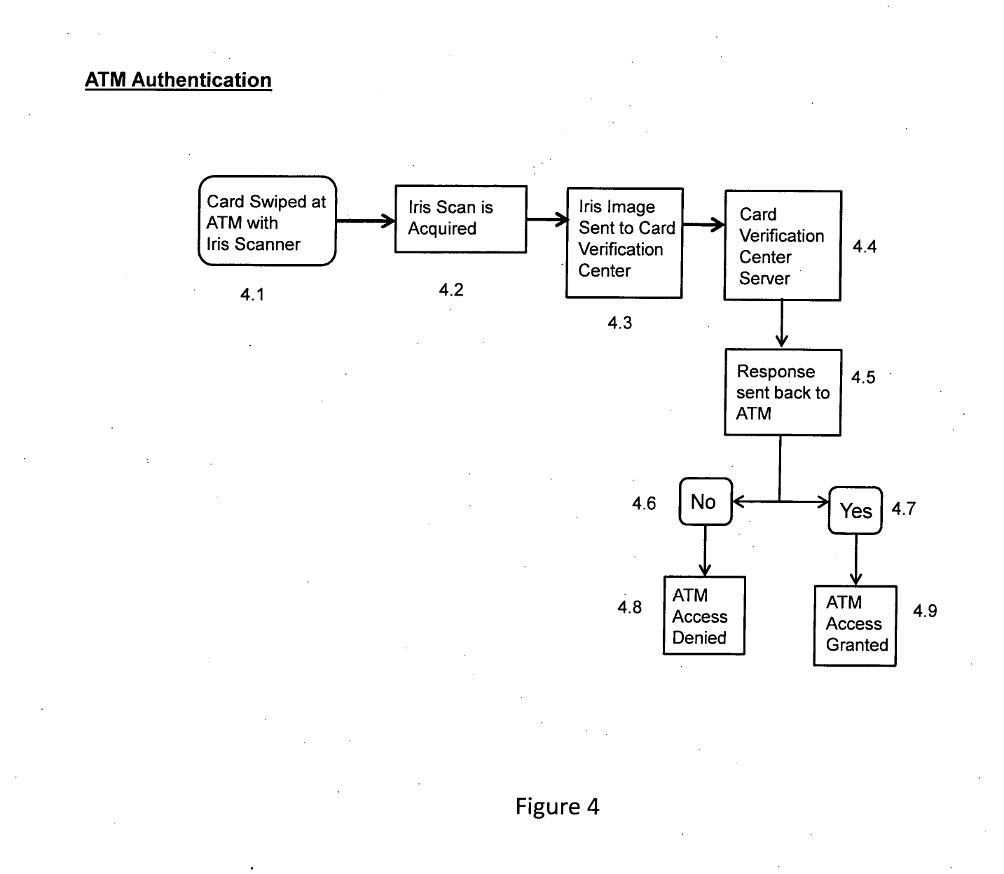

FIG. 5. is a flow chart view of the method of authentication and identification in mobile bank wire transfer transactions, using the encrypted mathematical value stored in the respective electronic, mobile or mobile telephone device as identification of the bank account Owner, prior to approval of the bank wire transfer transaction. In this case, the encrypted mathematical value representing the bank account Owner's iris image may be stored, with the Owner's prior opt-in express consent, on a remote issuing bank verification center server. If the two scanned images do not match, the transaction is refused.

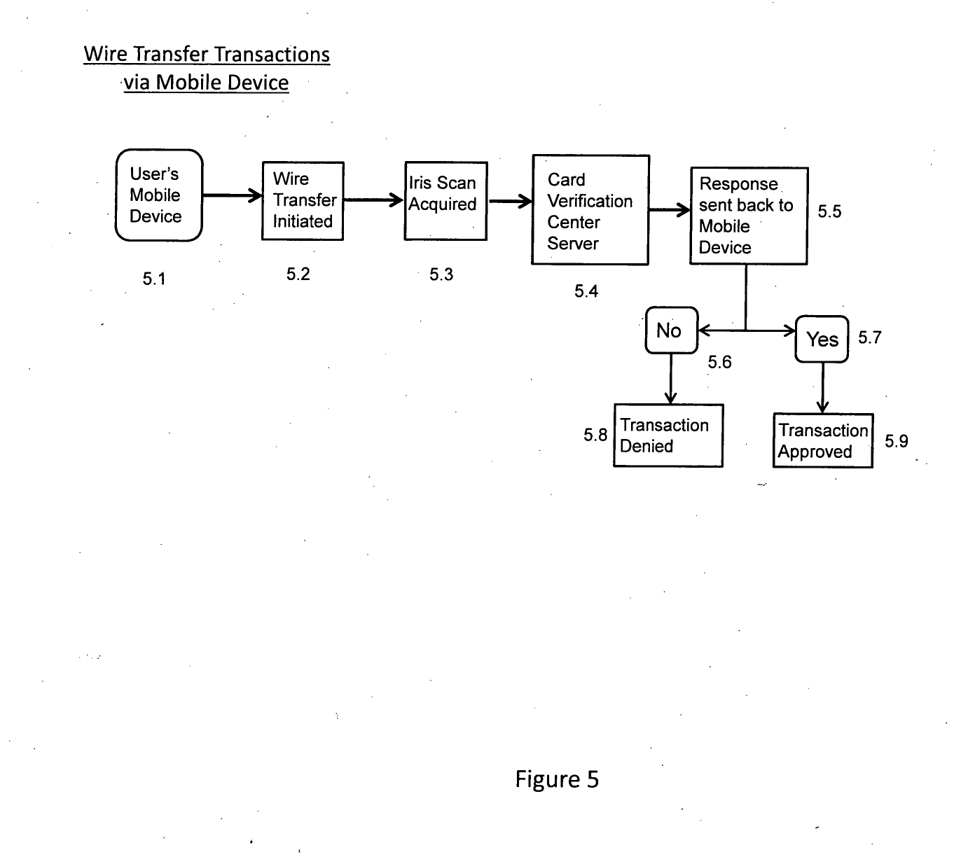

FIG. 6. is a flow chart view of the method of authentication and identification for use with on-line internet bank wire transfer transactions, using the encrypted mathematical value stored in the respective electronic, mobile or mobile telephone device as identification of the bank account Owner, prior to approval of the internet bank wire transfer transaction. In this case, the encrypted mathematical value representing the bank account Owner's iris image, may be stored, with the Owner's prior opt-in express consent, on a remote issuing bank verification center server. If the two scanned images do not match, the transaction is refused.

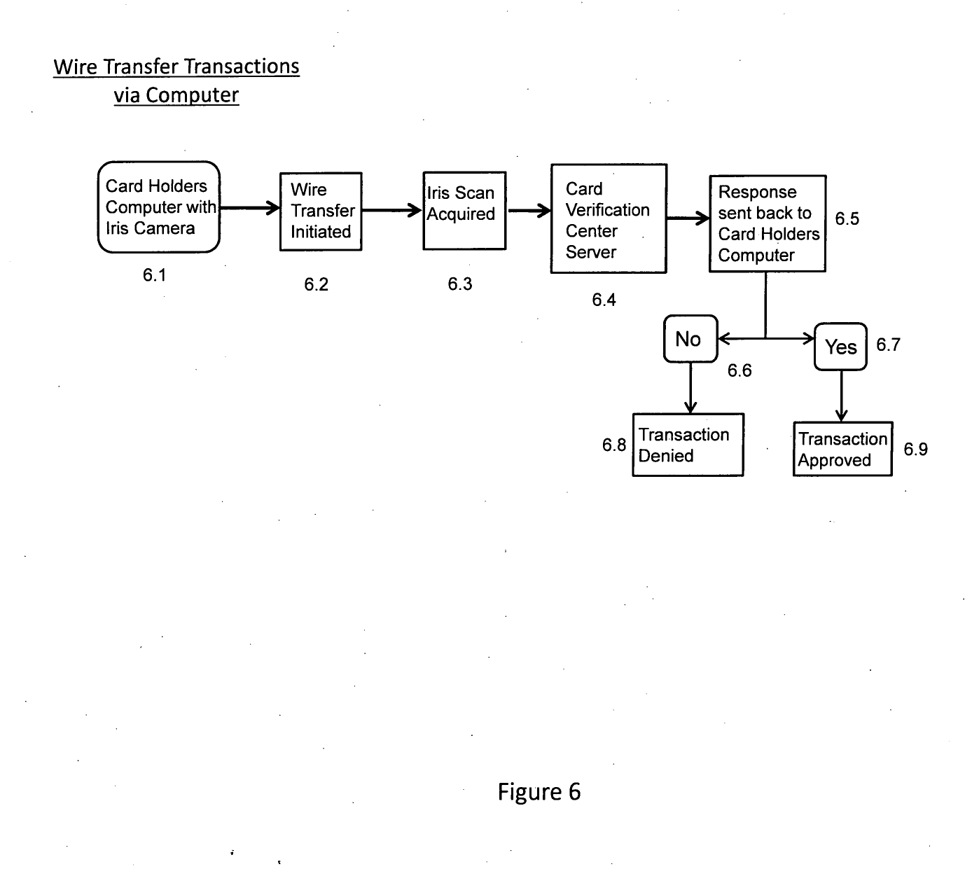

What is claimed is:

1. A method of iris scanning using a computer, laptop, mobile device or tablet, smartphone or i-phone, the method comprising:
selection of the iris scanning mode from software embedded in the chosen device to allow input of the iris image to be captured and stored into the device;
when in iris scanning mode, receiving alerts for sufficient light source and proximity of the iris to the device in order to optimize the image of the iris using light and proximity sensing and pre-determined analysis levels;
when in the iris scanning mode, photographing the iris when optimum light and proximity levels have been reached;
when in the iris scanning mode, storing the captured iris image within the selected device.

2. A method of converting the iris scan image to a mathematical value for storage in the computer, laptop, mobile device or tablet, smartphone or i-phone, as claimed in claim 1, wherein the iris scan image captured is converted to an encrypted mathematical value and said mathematical value is then stored in the chosen device.

3. A method of comparing the stored encrypted mathematical value, as claimed in claims 1 & 2, using an algorithm, which will compare subsequent acquired iris images, similarly converted to mathematical values as claimed in claim 2, to the stored encrypted mathematical value representing the original iris image, in order to determine whether or not the subsequent acquired images match the stored encrypted mathematical value.

4. A method of authentication, prior to approval of an ATM card transaction at any iris scan equipped ATM terminal, using the algorithm as claimed in claim 3, to compare the iris image of the purported credit card User to the stored, encrypted iris image of the credit card Owner, stored on the Owner's computer, laptop, tablet or other electronic computer device or stored on the issuing bank's remote server. If there is no exact match of the two iris images, through the method claimed in claim 3, the attempted ATM card transaction at the ATM terminal, will not be approved.

5. A method of authentication, prior to approval of a bank wire transfer transaction over the mobile channel, using the algorithm as claimed in claim 3, to compare the iris image of the purported bank wire transfer account holder to the stored, encrypted iris image of the bank account Owner, stored on the Owner's smartphone; i-phone or any other mobile device or on the depository bank's remote server. If there is no exact match of the two-iris images, through the method claimed in claim 3, the attempted bank wire transfer transaction over the mobile channel, will not be approved.

6. A method of authentication, prior to approval of a bank wire transfer transaction over the internet, using the algorithm as claimed in claim 3, to compare the iris image of the purported wire transfer account holder scanned over the computer, laptop, tablet, or other electronic device to the stored, encrypted iris image of the credit card Owner, stored on the Owner's mobile device or tablet, smartphone, i-phone, computer or laptop. If there is not exact match of the two iris images, through the method claimed in claim 3, the attempted bank wire transfer transaction over the internet will not be approved.
